(19) United States
(12) Patent Application Publication
(10) Pub. No.: US 2022/0230301 A1
(43) Pub. Date: Jul. 21, 2022

(54) Manufacturing Method And Image Processing Method and System For Quality Inspection Of Objects Of A Manufacturing Method

(71) Applicant: Aisapack Holding SA, Vouvry (CH)

(72) Inventors: Jacques Thomasset, Neuvecelle (FR); Yan Gex-Collet, Monthey (CH); Gaël Bussien, Le Bouveret (CH); Yann Lepoittevin, Lausanne (CH); François Fleuret, Yverdon-les-Bains (CH); Florent Monay, Monthey (CH); Filipe Bento Raimundo, Romanel-sur-Lausanne (CH); Salim Kayal, Vevey (CH)

(21) Appl. No.: 17/713,254

(22) Filed: Apr. 5, 2022

Related U.S. Application Data
(63) Continuation-in-part of application No. PCT/IB2020/057678, filed on Aug. 14, 2020.

(30) Foreign Application Priority Data
Oct. 15, 2019 (EP) 19203285.2

(51) Int. Cl. G06T 7/00; G06T 7/13

(52) U.S. Cl. CPC G06T 7/0004; G06T 2207/20081; G06T 7/13

(57) ABSTRACT

An automated method for manufacturing objects, the method using an image capturing device and a data processing device for quality inspection, wherein the method includes a learning phase and a manufacturing phase for manufacturing the objects, wherein the learning phase comprises producing N objects considered to be acceptable; taking at least one reference primary image of each of the N objects; dividing each reference primary image into (Pₖ) reference secondary images (S_{k,p}), grouping the corresponding reference secondary images into batches of N images, and determining a compression-decompression model (F_{k,p}) with a compression factor (Q_{k,p}) per batch.

### CROSS-REFERENCE TO RELATED APPLICATIONS

The present patent application claims benefit of priority to International patent application No. PCT/IB2020/057678 that was filed on Aug. 14, 2020 and that designated the United States, and is also a continuation-in-part (CIP) and “bypass” application under 35 U.S.C. §§ 111(a) and 365(c) of said International patent application, and claims foreign priority to European Patent Application No. EP 19203285.2 that was filed on Oct. 15, 2019, the contents of both these document being herewith incorporated by reference in their entirety.

### FIELD OF THE INVENTION

The present invention is directed to the field of mass-manufactured objects requiring a meticulous visual inspection during manufacture. The invention applies more particularly to high-throughput processes for manufacturing objects requiring a visual inspection that is integrated into the manufacturing line. Moreover, the present invention is also directed to the field of image processing for quality inspection of manufactured goods.

### BACKGROUND

Some image analysis and learning systems and methods are known in the prior art. Some examples are given in the following publications: WO 2018/112514, U.S. Pat. Nos. 10,710,119, 9,527,115, U.S. Patent Publication No. 2014/0071042 and WO 2017/052592, WANG JINJIANG ET AL. “Deep learning for smart manufacturing: Methods and applications” JOURNAL OF MANUFACTURING SYSTEMS, SOCIETY OF MANUFACTURING ENGINEERS, DEARBORN, Mich., US, vol. 48, Jan. 8, 2018 (2018-01-08), pages 144-156, MEHMOOD KHAN ET AL.: “An integrated supply chain model with errors in quality inspection and learning in production”, OMEGA., vol. 42, no. 1, Jan. 1, 2014, pages 16-24, WANG TIAN ET AL: “A fast and robust convolutional neural network-based defect detection model in product quality control”, THE INTERNATIONAL JOURNAL OF ADVANCED MANUFACTURING TECHNOLOGY, SPRINGER, LONDON, vol. 94, no. 9, Aug. 15, 2017, pages 3465-3471, JUN SUN ET AL: “An adaptable automated visual inspection scheme through online learning”, THE INTERNATIONAL JOURNAL OF ADVANCED MANUFACTURING TECHNOLOGY, SPRINGER, BERLIN, Del., vol. 59, no. 5-8, Jul. 28, 2011, pages 655-667, these references herewith incorporated by reference in their entirety.

### SUMMARY

According to some aspects of the present invention, an objective criteria for quantifying the aesthetics of objects is defined, for example objects such as manufactured tubes, in production. This quantification at present relies on human assessment, and it is highly challenging. The produced objects are all different, meaning that the concept of a defect is relative, and it is necessary to define what is or is not an acceptable defect in relation to produced objects, and not in an absolute manner.

According to some aspects of present invention, a learning phase allows to define a “standard” of what is acceptable for produced objects. In the invention, the concept of an “acceptable or unacceptable defect”, that is to say of an object considered to be “good” or “defective”, is defined in relation to a certain level of deviation from the standard predefined during learning. With at least some aspects of the present invention, it is possible to guarantee a constant level of quality over time. In addition, it is possible to reuse formulations, that is to say standards that have already been established previously, for subsequent productions of the same object.

The level of quality may be adjusted over time depending on the observed differences through iterative learning: during production, the standard defined by the initial learning is fine-tuned by “additional” learning that takes into account objects produced in the normal production phase but that exhibit defects that are considered to be acceptable. It is therefore necessary to adapt the standard so that it incorporates this information and that the process does not reject these objects.

Moreover, with some aspects of the present invention, it possible to inspect the objects in a very short time and, to achieve this performance, it uses a compression-decompression model for images of the objects, as described in detail in the present application.

In the frame of the present invention, the constraints in place and the problems to be solved are in particular as follows:
The visual inspection takes place during the manufacture of the object, the inspection time is therefore short because it must not slow down the production throughput, or at most have a slight impact thereon
Esthetic defects are not known (no defect library)
Esthetic defects vary depending on the decor
The defect acceptance level should be adjustable.

The method and system proposed herein described below makes it possible to mitigate the abovementioned drawbacks and overcome the problems identified.

Moreover, according to another aspect of the present invention, an automated system including an image capturing device and a data processing device is provided. Preferably, the data processing device is configured to perform image data processing for quality inspection of manufactured objects, and the data processing device is further configured to perform a method including a learning phase and a manufacturing phase.

In addition, according to another aspect of the present invention, a non-transitory computer readable medium is provided, the computer readable medium having computer instructions recorded thereon, the computer instructions configured to perform an automated method for manufacturing objects. Preferably, the method uses an image capturing device and a data processing device for quality inspection, wherein the method includes a learning phase and a manufacturing phase for manufacturing the objects.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is one example of an object being manufactured;

FIG. 2 shows the primary images taken during the learning phase of the method;

FIG. 3 illustrates the division of the primary images into secondary images, according to a step of the method;

FIG. 4 shows the learning phase, and in particular the formation of batches of secondary images in order to ultimately obtain a compression-decompression model per batch;

FIG. 5 illustrates the use of the compression-decompression model in the production phase;

FIG. 6 describes the main steps of the learning phase in the form of a block diagram;

FIG. 7 describes the main steps of the production phase in the form of a block diagram; and

FIGS. 8A and 8B shows an exemplary illustration of a system that can capture and process images captured from an object in a production line, showing two stages for capturing different images from objects, according to another aspect of the present invention.

Herein, identical reference numerals are used, where possible, to designate identical elements that are common to the figures. Also, the representations of the figures are simplified for illustration purposes and may not be depicted to scale.

### DETAILED DESCRIPTION OF THE SEVERAL EMBODIMENTS

First, some definitions are given that are used throughout the present specification.
Object: object being manufactured on an industrial line
N: number of objects forming a batch of the learning phase. N also corresponds to the number of secondary images forming a batch
Primary image: image taken of the object or of portion of the object
K: number of primary images per object
Aₖ: primary image of index k, where 1≤k≤K
Secondary image: portion of the primary image
Pₖ: number of secondary images per primary image AₖS_{k,p}: Secondary image of index k associated with the primary image Aₖ and of index p, where 1≤p≤Pₖ
Model F_{k,p}: compression-decompression model associated with the secondary image S_{k,p}
Compression factor Q_{k,p}: compression factor of the model F_{k,p}
Reconstructed secondary image R_{k,p}: Secondary image reconstructed from the secondary image S_{k,p} with the associated model F_{k,p}.

According to aspects of the present invention, a method or process for manufacturing objects is provided, such as for example packaging such as tubes, comprising a visual inspection integrated into one or more steps of the process for producing the objects. The manufacturing process according to the invention comprises at least two phases for performing the visual inspection:
A learning phase, during which a batch of objects deemed to be “of good quality” are produced, and at the end of which criteria are defined based on the images of the objects.
A production phase, during which the image of the objects being produced and the criteria defined during the learning phase are used to quantify, in real time, the quality of the objects being produced and to control the production process.

During the learning phase, the machine produces a number N of objects deemed to be of acceptable quality. One (K=1) or several separate images (K>1), called primary image(s) of each object, is (are) collected during the process of producing the objects. The K×N primary images that are collected undergo digital processing, which will be described in more detail below and which comprises at least the following steps:
Repositioning each primary image Aₖ
Dividing each primary image Aₖ into Pₖ secondary images, denoted S_{k,p}, where 1≤k≤K and 1≤p≤Pₖ
Grouping the secondary images into batches of N similar images.
For each batch of secondary images S_{k,p}:
   Searching for a compressed representation F_{k,p} with a compression factor Q_{k,p},
   From each batch of secondary images, thus deducing therefrom a compression-decompression model F_{k,p} with a compression factor Q_{k,p}. One particular case of the invention consists in having the same compression factor for all of the models F_{k,p}. Adjusting the compression rate Q_{k,p} to each model F_{k,p} makes it possible to adjust the level of detection of defects and to optimize the computing time depending on the area under observation of the object.

At the end of the learning phase, there is therefore a model F_{k,p} and a compression factor Q_{k,p} per area under observation of the object; each area being defined by a secondary image S_{k,p}.

As will be explained in more detail below, each secondary image of the object has its own dimensions. One particular case of the invention consists in having all the secondary images in the same size. In some cases, it is advantageous to be able to locally reduce the size of the secondary images in order to detect smaller defects. By jointly adjusting the size of each secondary image S_{k,p} and the compression factor Q_{k,p}, the invention makes it possible to optimize the computing time while at the same time maintaining a high-performance detection level adjusted to the requirement level linked to the manufactured product. The invention makes it possible to locally adapt the detection level to the level of criticality of the area under observation.

During the production phase, K what are called “primary” images of each object are used to inspect, in real time, the quality of the object being produced, thereby making it possible to remove any defective objects from production as early as possible and/or to adjust the process or the machines when deviations are observed.

To inspect the object being produced in real time, the K primary images of the object are evaluated via a method described in the present application with respect to the group of primary images acquired during the learning phase, from which compression-decompression functions and compression factors are extracted and applied to the images of the object being produced. This comparison between images acquired during the production phase and images acquired during the learning phase gives rise to the determination of one or more scores per object, the values of which make it possible to classify the objects with respect to thresholds corresponding to visual quality levels. Through the value of the scores and the predefined thresholds, defective objects are able to be removed from the production process. Other thresholds may be used to detect deviations of the manufacturing process, and allow the process to be corrected or an intervention on the production tool before defective objects are formed.

At least a part of the invention lies in the computing of the scores, which makes it possible, through one or more numerical values, to quantify the visual quality of the objects in production. Computing the scores of each object in production requires the following operations:
Acquiring primary images Aₖ of the object in production;
Repositioning each primary image with respect to the respective reference image;
Dividing the K primary images into secondary images S_{k,p} using the same breakdown as that implemented during the learning phase;
Computing the reconstructed image R_{k,p} of each secondary image S_{k,p} using the model F_{k,p} and the factor Q_{k,p} defined during the learning phase;
Computing the reconstruction error of each secondary image by comparing the secondary image S_{k,p} and the reconstructed secondary image R_{k,p}. The set of secondary images of the object therefore gives the set of reconstruction errors; and
The scores of the object are computed from the reconstruction errors.

Using the numerical model F_{k,p} with a compression factor Q_{k,p} makes it possible to greatly reduce the computing time and ultimately makes it possible to inspect the quality of the object during the manufacturing process and to control the process. The method is particularly suitable for processes of manufacturing objects with a high production throughput.

The herein presented method and system can advantageously be used in the field of packaging to inspect for example the quality of packaging intended for cosmetic products. The invention is particularly advantageous for example for manufacturing cosmetic tubes or bottles.

The herein presented method and system may be used in a continuous manufacturing process. This is the case for example in the process of manufacturing packaging tubes, in which a multilayer sheet is welded continuously to form the tubular body. It is highly advantageous to continuously inspect the aesthetics of the manufactured tube bodies, and in particular the weld area.

The herein presented method and system may be used in a discontinuous manufacturing process. This is the case for example in the manufacture of products in indexed devices. This is for example a process of assembling a tube head on a tube body by welding. The invention is particularly advantageous for inspecting, in the assembly process, the visual quality of the welded area between the tube body and the tube head.

The herein presented method and system primarily targets object manufacturing processes in automated production lines. The invention is particularly suited to the manufacture of objects at high production throughputs, such as objects produced in the packaging sector or any other sector having high production throughputs.

According to some aspects of the present invention, there is no need for a defect library for defining their location, or their geometry, or their color. Defects are detected automatically during production once the learning procedure has been performed.

In one embodiment, the process for manufacturing objects, such as tubes or packaging, comprises at least one quality inspection integrated into the manufacturing process, performed during production and continuously, the quality inspection comprising a learning phase and a production phase. The learning phase can comprise at least the following steps:
producing N objects considered to be acceptable;
taking at least one reference primary image (Ak) of each of the N objects;
dividing each reference primary image (Ak) into (Pk) reference secondary images (Sk,p);
grouping the corresponding reference secondary images into batches of N images;

and
determining a compression-decompression model (Fk,p) with a compression factor (Q_{k,p}) per batch.

The production phase can comprise at least the following steps:
taking at least one primary image of at least one object in production;
dividing each primary image into secondary images (S_{k,p});
applying the compression-decompression model and the compression factor defined in the learning phase to each secondary image (S_{k,p}) so as to form a reconstructed secondary image (R_{k,p});
computing the reconstruction error of each reconstructed secondary image R_{k,p};
assigning one or more scores per object based on the reconstruction errors; and
determining whether or not the produced object successfully passes the quality inspection based on the one or more assigned score(s).

In embodiments, after the step of taking at least one primary image (in the learning and/or production phase), each primary image is repositioned.

In embodiments, each primary image is processed for example digitally. The processing operation may for example involve a digital filter (such as Gaussian blur) and/or edge detection, and/or applying masks to hide certain areas of the image, such as for example the background or areas of no interest.

In other embodiments, multiple analysis is performed on one or more primary images. Multiple analysis consists in applying multiple processing operations simultaneously to the same primary image. A “mother” primary image may thus give rise to multiple “daughter” primary images depending on the number of analyses performed. For example, a “mother” primary image may undergo a first processing operation with a Gaussian filter, giving rise to a first “daughter” primary image, and a second processing operation with a Sobel filter, giving rise to a second “daughter” primary image. The two “daughter” primary images undergo the same digital processing operation defined in the invention for the primary images. Each “daughter” primary image thus may be associated with one or more scores. Moreover, among the primary images that are initially taken (in the learning phase and in the production phase), it may be decided to apply multiple analysis to all of the primary images, or only to some of them (or even only to one primary image). Next, all of the primary images (the “daughter” images that result from the multiple analysis and the others to which the multiple analysis has not been applied) are processed with the process according to the invention.

Multiple analysis is beneficial when highly different defects are sought on the objects. Multiple analysis thus makes it possible to adapt the analysis of the images to the sought defect. This method allows a greater detection finesse for each type of defect. In embodiments, the compression factor is between 5 and 500 000, preferably between 100 and 10 000. In embodiments, the compression-decompression function may be determined from a principal component analysis (“PCA”). In embodiments, the compression-decompression function may be determined by an auto-encoder. In embodiments, the compression-decompression function may be determined using the algorithm known as the “OMP” (Orthogonal Matching Pursuit) algorithm. In embodiments, the reconstruction error may be computed using the Euclidean distance and/or the Minkowski distance and/or the Chebyshev method. In embodiments, the score may correspond to the maximum value of the reconstruction errors and/or to the average of the reconstruction errors and/or to the weighted average of the reconstruction errors and/or to the Euclidean distance and/or the p-distance and/or the Chebyshev distance. In embodiments, N may be equal to at least 10. In embodiments, at least two primary images are taken, the primary images being of identical size or of different size. In embodiments, each primary image may be divided into P secondary images of identical size or of different size. In embodiments, the secondary images S may be juxtaposed with overlap or without overlap. In embodiments, some secondary images may be juxtaposed with overlap and other secondary images are juxtaposed without overlap. In embodiments, the secondary images may be of identical size or of different size. In embodiments, the integrated quality inspection may be performed at least once in the manufacturing process. In embodiments, the learning phase may be iterative and repeated during production with objects in production in order to take into account a difference that is not considered to be a defect.

In embodiments, the repositioning may be to consider a predetermined number of points of interest and descriptors distributed over the image and to determine the relative displacement between the reference image and the primary image that minimizes the overlay error at the points of interest. In embodiments, the points of interest may be distributed randomly in the image or in a predefined area of the image. In embodiments, the position of the points of interest may be arbitrarily or non-arbitrarily predefined. In embodiments, the points of interest may be detected using one of the methods known as “SIFT”, or “SURF”, or “FAST”, or “ORB”; and the descriptors defined by one of the methods “SIFT”, or “SURF”, or “BRIEF”, or “ORB”. See for example Rublee et al., “ORB: An efficient alternative to SIFT or SURF.” International conference on computer vision, pp. 2564-2571, IEEE, year 2011, see also for example Karami et al., “Image matching using SIFT, SURF, BRIEF and ORB: performance comparison for distorted images.” arXiv preprint arXiv:1710.02726, year 2017, these references herewith incorporated by reference in their entirety.

In embodiments, the image may be repositioned along at least one axis and/or the image may be repositioned in rotation about the axis perpendicular to the plane formed by the image and/or the image may be repositioned by combining a translational and rotational movement.

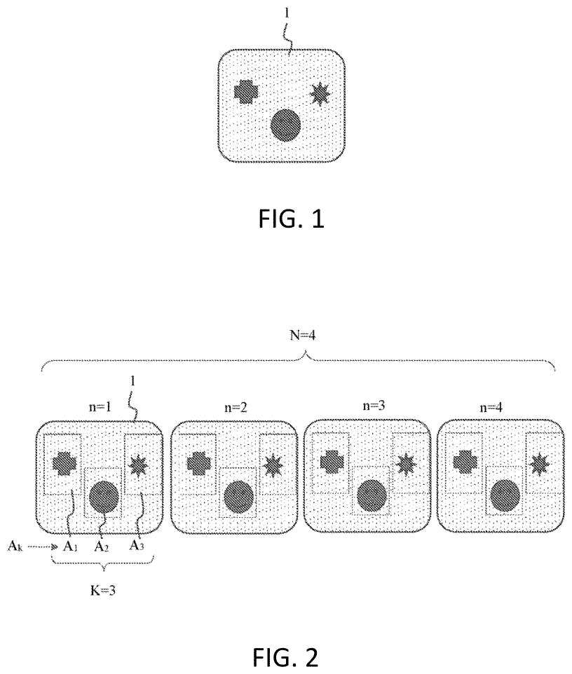

FIG. 1 illustrates an object 1 being manufactured. To illustrate the invention and make the invention easier to understand, three decorative patterns have been shown on the object, as a non-limiting example. The invention makes it possible to inspect the quality of these patterns on the objects being produced. The invention makes it possible to inspect any type of object or portion of an object. The objects may be considered to be unit parts or portion according to the example shown in FIG. 1. In other processes, such as manufacturing tubes by welding a printed laminate that is unrolled and formed in a continuous process; the object is defined by the dimension of the repetitive decorative pattern on the tube being formed. In another scenario where it would be complicated to define the size of the object, such as for example a continuous extrusion process for a sheet or a tube, the object may be defined arbitrarily by the dimension of the image, taken at regular intervals, of the extruded product.

FIG. 2 illustrates one example of primary images of the object, taken during the learning phase. During this learning phase, N objects deemed to be of acceptable quality are produced. To facilitate the illustration of the invention, only 4 objects have been shown in FIG. 2 by way of example. To obtain a robust model, the number of objects required during the learning phase should be greater than 10 (that is to say N>10), and preferably greater than 50 (that is to say N>50). Of course, these values are non-limiting examples, and N may be less than or equal to 10. FIG. 2 shows the three (3) exemplary primary images A₁, A₂ and A₃ respectively showing distinct patterns printed on the object. Herein, the term Aₖ is used to denote the primary images of the object, the index k of the image varying between 1 and K; and K corresponding to the number of images per object.

As illustrated in FIG. 2, the size of the primary images Aₖ is not necessarily identical. In FIG. 2, the primary image A₂ is smaller than the primary images A₁ and A₃. This makes it possible for example to have an image A₂ with better definition (greater number of pixels). The primary images may cover the entire surface of the object 1 or, on the contrary, only partially cover its surface. As illustrated in FIG. 2, the primary images Aₖ target specific areas of the object. This flexibility of the invention in terms of size, position and number of primary images makes it possible to optimize the computing time while at the same time maintaining high accuracy in terms of inspecting visual quality in the most critical areas.

FIG. 2 also illustrates the need to produce images A₁ that are similar from one object to another. This requires putting in place appropriate means for repeatedly positioning the object or the camera when taking images Aₖ. As will be explained later in the disclosure of the invention, despite the means implemented in order to be repetitive from one image to another, it is often necessary to reposition the primary images with respect to a reference image in order to overcome the variations inherent to taking an image in an industrial manufacturing process, as well as the variations inherent to the objects produced. The images are repositioned with high accuracy, since it is small elements of the image, such as for example the pixels, that are used to perform this repositioning.

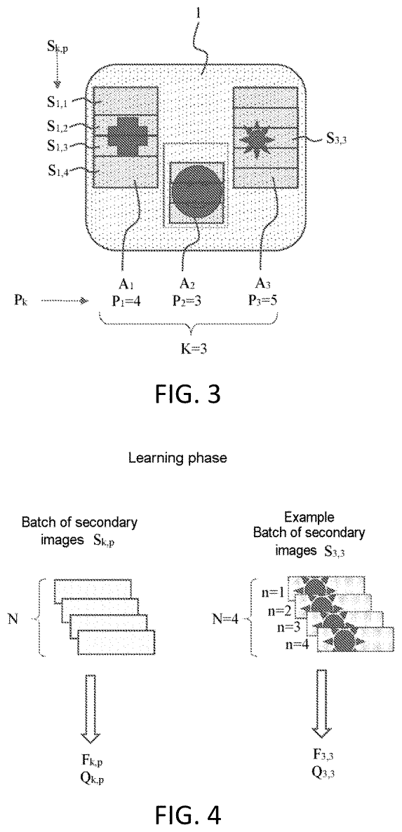

FIG. 3 shows the division of the primary images into secondary images. Thus, as illustrated in FIG. 3, the primary image A₁ is divided into 4 secondary images S_{1,1}, S_{1,2}, S_{1,3} and S_{1,4}. Each primary image Aₖ is thus broken down into Pₖ secondary images S_{k,p} with the division index p which varies between 1 and Pₖ. As illustrated in FIG. 3, the size of the secondary images is not necessarily identical. By way of example, FIG. 3 shows that the secondary images S_{1,2} and S_{1,3} are smaller than the secondary images S_{1,1} and S_{1,4}. This makes it possible to have a more accurate defect search in the secondary images S_{1,2} and S_{1,3}. As also shown in FIG. 3, the secondary images do not necessarily cover the entire primary image Aₖ. By way of example, the secondary images S_{2,p} only partially cover the primary image A₂. By reducing the size of the secondary images, the analysis is focused in a specific area of the object. Only the areas of the object that are covered by the secondary images are analyzed. FIG. 3 also illustrates the fact that the invention makes it possible to locally adjust the level of inspection of the aesthetics of the object by adjusting the number, the size and the position of the secondary images S_{k,p}.

FIG. 4 illustrates the learning phase, and in particular the formation of batches of secondary images in order to ultimately obtain a compression-decompression model with a compression factor per batch. FIG. 4 shows the grouping of the N similar secondary images S_{k,p} to form a batch. Each batch is processed separately and is used to create a compression-decompression model F_{k,p} with a compression factor Q_{k,p}. Thus, by way of example and as illustrated in FIG. 3, the N=4 secondary images S_{3,3} are used to create the model F_{3,3} with a compression factor Q_{3,3}.

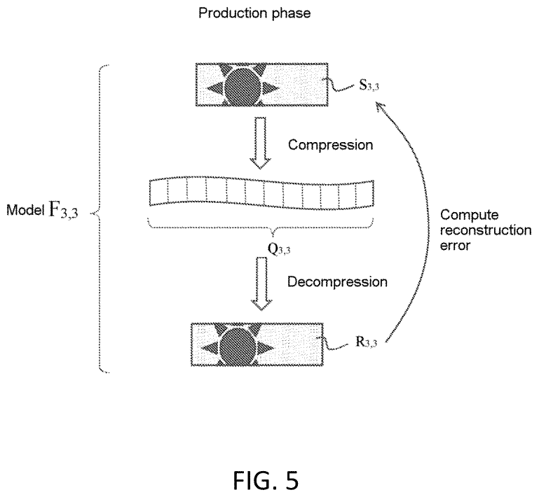

FIG. 5 illustrates the use of the compression-decompression model stemming from the learning phase in the production phase. In the production phase, each model F_{k,p} determined in the learning phase is used to compute the reconstructed image of each secondary image S_{k,p} of the object being manufactured. Each secondary image of the object therefore undergoes a compression-decompression operation with a model and a different compression factor resulting from the learning phase. Each compression-decompression operation gives a reconstructed image that may be compared with the secondary image from which it results. Comparing the secondary image S_{k,p} and its reconstructed image R_{k,p} makes it possible to compute a reconstruction error that will be used to define a score. FIG. 5 illustrates, by way of illustrative example, the particular case of obtaining the reconstructed image R_{3,3} from the secondary image S_{3,3} using the model F_{3,3} and its compression factor Q_{3,3}.

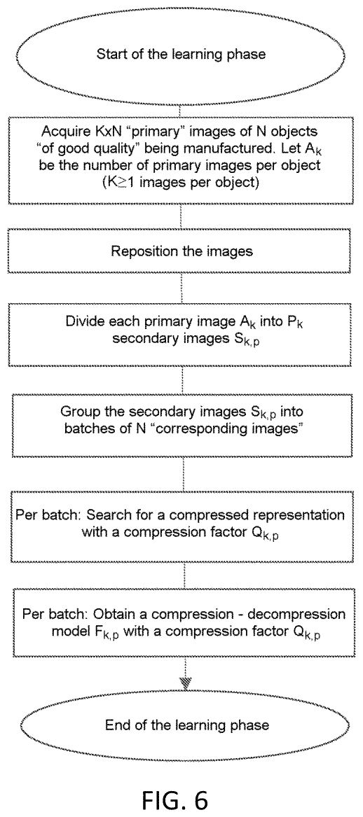

FIG. 6 shows the main steps of the learning phase according to the present invention. At the start of the learning phase, N objects deemed to be of acceptable quality are produced. The qualitative and/or quantitative assessment of the objects may be carried out using visual inspection procedures or using methods and means defined by the company. The number of objects produced for the learning phase may therefore be equal to N or greater than N. The learning phase illustrated in FIG. 6 comprises at least the following steps:
Acquiring K×N what are called “primary” images of objects deemed to be of good quality during the manufacture of the objects. Each object may be associated with one (K=1) or several (K>1) distinct primary images depending on the dimensions of the area to be analyzed on the object and the size of the defects that it is desired to detect. Lighting and magnification conditions appropriate to the industrial context are implemented in order to allow images to be taken in a relatively constant light environment. Known lighting optimization techniques may be implemented in order to avoid reflection phenomena or interference linked to the environment. Many commonly used solutions may be adopted, such as for example tunnels or black boxes that make it possible to avoid external light interference, and/or lights with specific wavelengths and/or lighting systems with grazing light or indirect lighting. When several primary images are taken on one and the same object (K>1), the primary images may be spaced, juxtaposed or even overlap. The overlapping of the primary images may be useful when it is desired to avoid cutting a potential defect that might occur between two images, and/or to compensate for the loss of information on the edge of the image linked to the step of repositioning the images. These techniques may also be combined depending on the primary images and the information contained therein. The image may also be pre-processed using optical or digital filters in order to increase the contrast, for example.
Next, the primary images are repositioned with respect to a reference image. In general, the primary images of any object produced during the learning phase may serve as reference images. Preferably, the primary images of the first object produced during the learning phase are used as reference images. The methods for repositioning the primary image are detailed later in the description of the present application.
Each primary image Aₖ is then divided into Pₖ images, called “secondary” images. Dividing the image may result in an analysis area smaller than the primary image. Reducing the analysis area may be beneficial when it is known, a priori, in which area of the object to look for possible defects. This is the case for example for objects manufactured through welding and for which defects linked to the welding operation are sought. The secondary images may be spaced from one another, leaving “non-analyzed” areas between them. This scenario may be used for example when the defects occur in targeted areas, or when the defects occur repeatedly and continuously. Reducing the analysis area makes it possible to reduce computing times. As an alternative, the secondary images may be overlaid. The overlapping of the secondary images makes it possible to avoid cutting a defect into two parts when the defect occurs at the join between two secondary images. The overlapping of the secondary images is particularly useful when looking for small defects. Finally, the secondary images may be juxtaposed without a spacing or an overlap. The primary image may be divided into secondary images of identical or variable sizes, and the techniques for the relative positioning of the secondary images (spaced, juxtaposed or overlaid) may also be combined depending on the defects sought.
The next step consists in grouping the corresponding secondary images into batches. The secondary images obtained from the K×N primary images give rise to a set of secondary images. From this set of secondary images, it is possible to form batches containing N corresponding secondary images, specifically the same secondary image S_{k,p} of each object. The N secondary images S_{1,1} are thus grouped into a batch. The same applies for the N images S_{1,2}, then for the N images S_{1,3}, and so on for all of the images S_{k,p}.
The next step consists in finding a compressed representation per batch of secondary images. This operation is a key step of the invention. It consists in particular in obtaining a compression-decompression model F_{k,p} with a compression factor Q_{k,p} that characterize the batch. The models F_{k,p} will be used to inspect the quality of objects during the production phase. This thus gives the model F_{1,1} with compression criterion Q_{1,1} for the batch of secondary images S_{1,1}. Likewise, the model F_{1,2} is obtained for the batch of images S_{1,2}; then the model F_{1,3} is obtained for the batch of images S_{1,3}; and so on a model F_{k,p} is obtained for each batch of images S_{k,p}.
The choice of the compression factor Q_{k,p} per batch of secondary images S_{k,p} depends on the available computing time and the size of the defect that it is desired to detect.
At the end of the learning phase, there is a set of models F_{k,p} with a compression factor Q_{k,p} that are associated with the visual quality of the object being produced.

According to some aspects of the present invention, the results of the learning phase, which are the models F_{k,p} and the compression factors Q_{k,p}, may be kept as a “formulation” and reused later when producing the same objects again. Objects of identical quality may thus be reproduced later, reusing the predefined formulation. This also makes it possible to avoid carrying out a learning phase again prior to the start of each production of the same objects.

According to some aspects of the present invention, it is possible to have iterative learning during production. Thus, during production, it is possible for example to carry out additional (or complementary) learning with new objects and to add the images of these objects to the images of the objects initially taken into account in the learning phase. A new learning phase may be performed from the new set of images. Adaptive learning is particularly suitable if a difference between the objects occurs during production and this difference is not considered to be a defect. In other words, these objects are considered to be “good” as in the initial learning phase, and it is preferable to take this into account. In this scenario, iterative learning is necessary in order to avoid a high rejection rate that would include objects exhibiting this difference. The iterative learning may be carried out in many ways, either for example by accumulating the new images with the previously learned images; or by restarting learning with the new learned images; or even keeping only a few initial images with the new images.

According to some aspects of the present invention, the iterative learning is triggered by an indicator linked to the rejection of the objects. This indicator is for example the number of rejections per unit of time or the number of rejections per quantity of object produced. When this indicator exceeds a fixed value, the operator is alerted and decides whether the increase in the rejection rate requires a machine adjustment (because the differences are defects) or new learning (because the differences are not defects).

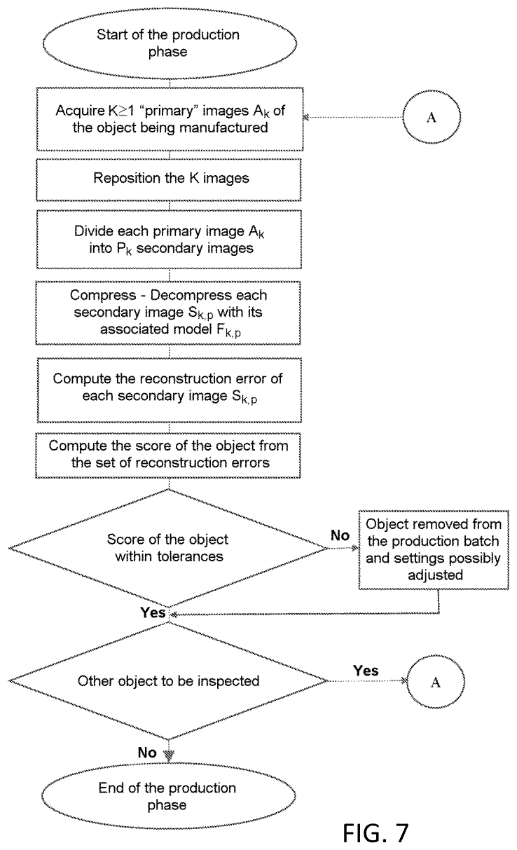

FIG. 7 shows the main steps of the object production phase. The production phase starts after the learning phase, that is to say when the characteristic criteria of objects of acceptable “quality” have been defined as described above. The invention makes it possible to remove, in real time, defective objects from the production batch, and to avoid the production of excessive waste when a deviation in the produced quality is observed. The invention also makes it possible to signal, in real time, deviations of the production process, and to anticipate the production of defective objects. Indeed, it is then possible to act on the production tool (such as the machines) in order to correct the production process and correct the detected defects, or correct a deviation. The production phase according to the invention illustrated in FIG. 7 comprises at least the following operations:
Acquiring K primary images of the object being manufactured. The images of the object are taken in the same way as the images taken in the learning phase: the photographed areas and the lighting, magnification and adjustment conditions are identical to those used during the learning phase.
The K images are repositioned with respect to the reference images. The purpose of the repositioning operation is to overcome slight offsets between the images that it is desired to compare. These offsets may be linked to vibrations, or even to the relative movement between the objects and the imaging devices.
Each primary image Aₖ of the object in production is then divided into Pₖ secondary images. The division is performed in the same way as the division of the images carried out in the learning phase. At the end of this division, there is therefore a set of secondary images S_{k,p} per object in production.
Each secondary image S_{k,p} is then compressed-decompressed with the model F_{k,p} with a compression factor F_{k,p} that is predefined during the learning phase. This operation gives rise to a reconstructed image R_{k,p} for each secondary image S_{k,p}. This thus gives, for the object being produced, reconstructed images that are able to be compared with the secondary images of the object. From the digital point of view, the use of the term “reconstruction of the secondary image” does not necessarily mean obtaining a new image in the strict sense of the term. Since the aim is ultimately to compare the image of the object being produced with the images obtained in the learning phase by way of the compression-decompression functions and the compression factors, only the quantification of the difference between these images is strictly useful. For reasons of computing time, a choice may be made to draw a limit at a digital object representative of the reconstructed image and sufficient to quantify the difference between the secondary image and the reconstructed image. Using a model F_{k,p} is particularly advantageous as it makes it possible to perform this comparison in very short times compatible with the production requirements and throughputs.
A reconstruction error may be computed from the comparison of the secondary image and the reconstructed secondary image. The preferred method for quantifying this error is that of computing the mean squared error, but other equivalent methods are possible.
For each object, there are therefore secondary images and reconstructed images, and therefore reconstruction errors. From this set of reconstruction errors, one or more score(s) may be defined for the object being produced. Multiple computing methods are possible for computing the scores of the object that characterizes its resemblance or difference with respect to the learned batch. Thus, according to the invention, an object that is visually far away from the learning batch, because it exhibits defects, will have one or more high scores. Conversely, an object that is visually close to the learning batch will have one or more low scores, and will be considered to be of good quality or of acceptable quality. One preferred method for computing the one or more scores of the object consists in taking the maximum value of the reconstruction errors. Other methods consist in combining the reconstruction errors in order to compute the value of the one or more scores of the object.
The next step consists in removing defective objects from the production batch. If the value of the one or more scores of the object is (are) lower than one or more predefined limit(s), the evaluated object meets the visual quality criteria defined in the learning phase, and the object is kept in the production flow. Conversely, if the one or more values of the one or more scores of the object is (are) greater than the one or more limit(s), the object is removed from the production flow. When several successive objects are removed from the production flow, or when the reject rate becomes high, corrective actions to the process or interventions on the production machines may be contemplated.

The steps that can be performed by the method and system discussed are recapped and presented in more detail below.

With respect to the repositioning of the primary image, this step can comprise two sub steps:
Searching for points of interest and descriptors in the image
Repositioning the taken image with respect to the reference image based on the points of interest and the descriptors

Typically, the one or more reference images is/are defined on the first image taken in the learning phase or another image, as described in the present application. The first step consists in defining points of interest and descriptors associated with the points of interest on the image. The points of interest may for example be angular parts or portions in the shapes present on the image, and they may also be areas with high contrast in terms of intensity or color, or the points of interest may even be chosen randomly. The identified points of interest are then characterized by descriptors that define the features of these points of interest.

Preferably, the points of interest are determined automatically using an appropriate algorithm; however, one alternative method consists in arbitrarily predefining the position of the points of interest.

The number of points of interest used for the repositioning is variable and depends on the number of pixels per point of interest. The total number of pixels used for the positioning is generally between 100 and 10 000, and preferably between 500 and 1000.

A first method for defining the points of interest consists in choosing these points randomly. This is tantamount to randomly defining a percentage of pixels called points of interest, the descriptors being the features of the pixels (position, colors). This first method is particularly suited to the context of industrial production, especially in the case of high-throughput manufacturing processes where the time available for computing is very limited.

According to a first embodiment of the first method, the points of interest are distributed randomly in the image.

According to a second embodiment of the first method, the points of interest are distributed randomly in a predefined area of the image. This second embodiment is advantageous when it is known a priori where any defects will occur. This is the case for example for a welding process in which the defects are expected mainly in the area affected by the welding operation. In this scenario, it is advantageous to position the points of interest outside the area affected by the welding operation.

A second method for defining the points of interest is based on the method called “SIFT” (see for example U.S. Pat. No. 6,711,293, this reference herewith incorporated by reference in its entirety), that is to say a method that makes it possible to keep the same visual features of the image independently of the scale. This method consists in computing the descriptors of the image at the points of interest of the image. These descriptors correspond to digital information derived from the local analysis of the image and that characterizes the visual content of the image independently of the scale. The principle of this method consists in detecting areas defined around points of interest on the image; the areas being preferably circular with a radius called a scale factor. In each of these areas, shapes and their edges are sought, and then the local orientations of the edges are defined. Numerically, these local orientations translate into a vector that constitutes the “SIFT” descriptor of the point of interest.

A third method for defining the points of interest is based on the “SURF” (see for example U.S. Patent Publication No. 2009/0238460, this reference herewith incorporated by reference in its entirety) method, that is to say an accelerated method for defining the points of interest and the descriptors. This method is similar to the “SIFT” method, but has the advantage of speed of execution. This method comprises, like “SIFT”, a step of extracting the points of interest and of computing the descriptors. The “SURF” method uses the Fast-Hessian to detect the points of interest and an approximation of the Haar wavelets to compute the descriptors.

A fourth method for searching for the points of interest based on the “FAST” (Features from Accelerated Segment Test) method consists in identifying the potential points of interest and then analyzing the intensity of the pixels located around the points of interest. This method makes it possible to identify the points of interest very quickly. The descriptors may be identified via the “BRIEF” (Binary Robust Independent Elementary Features) method.

The second step of the image repositioning method consists in comparing the primary image with the reference image using the points of interest and their descriptors. Obtaining the best repositioning is achieved by searching for the best alignment between the descriptors of the two images.

The repositioning value of the image depends on the manufacturing processes and in particular on the accuracy of the spatial positioning of the object when the image is taken. Depending on the scenario, the image may require repositioning along a single axis, along two perpendicular axes or even rotational repositioning about the axis perpendicular to the plane formed by the image.

The repositioning of the image may result from the combination of translational and rotational movements. The optimum homographic transformation is sought via the least squares method.

The points of interest and the descriptors are used for the operation of repositioning the image. These descriptors may be for example the features of the pixels or the “SIFT”, “SURF” or “BRIEF” descriptors, by way of example. The points of interest and the descriptors are used as reference points for repositioning the image.

The repositioning in the SIFT, SURF and BRIEF methods is carried out by comparing the descriptors. Descriptors that are not relevant are removed using a consensus method, such as the Ransac method. Next, the optimum homographic transformation is sought via the least squares method.

The primary image may be divided into P secondary images in several ways, as further discussed below.

One benefit of the invention is that of making it possible to adjust the level of visual analysis to the area under observation of the object. This adjustment is initially performed by the number of primary images and the level of resolution of each primary image. The breakdown into secondary images then makes it possible to adjust the level of analysis locally in each primary image. A first parameter on which it is possible to intervene is the size of the secondary images. A smaller secondary image makes it possible to locally fine-tune the analysis. By jointly adjusting the size of each secondary image S_{k,p} and the compression factor Q_{k,p}, the invention makes it possible to optimize the computing time while at the same time maintaining a high-performance detection level adjusted to the requirement level linked to the manufactured product. The invention makes it possible to locally adapt the detection level to the level of criticality of the area under observation.

One particular case of the invention consists in having all the secondary images the same size. Thus, when the entire area under observation is of the same size, a first method consists in dividing the primary image into P secondary images of identical size and juxtaposed without overlap.

A second method consists in dividing the primary image into P secondary images of identical sizes and juxtaposed with overlap. The overlap is adjusted depending on the dimension of the defects likely to occur on the object. The smaller the defect, the more the overlap may be reduced. In general, it is considered that the overlap is at least equal to the characteristic half-length of the defect; the characteristic length being defined as the smallest diameter of the circle that makes it possible to contain the defect in its entirety. Of course, it is possible to combine these methods and use secondary images that are juxtaposed and/or with overlap and/or at a certain distance from one another.

According to a first method, which is also the preferred method, the compression-decompression functions and the compression factors are computed or otherwise determined from a principal component analysis (“PCA”). This method makes it possible to define the eigenvectors and eigenvalues that characterize the batch resulting from the learning phase. In the new base, the eigenvectors are ranked in order of importance. The compression factor stems from the number of dimensions that are retained in the new base. The higher the compression factor, the lower the number of dimensions of the new base. The invention makes it possible to adjust the compression factor depending on the desired level of inspection and depending on the available computing time.

A first advantage of this method is linked to the fact that the machine does not need any indication to define the new base. The eigenvectors are chosen automatically through computation.

A second advantage of this method is linked to the reduction of the computing time to detect defects in the production phase. The amount of data to be processed is reduced since the number of dimensions is reduced.

A third advantage of the method results in the possibility of assigning one or more scores, in real time, to the image of the object being produced. The one or more scores obtained make it possible to quantify a deviation/error rate of the object being manufactured with respect to the objects from the learning phase by virtue of its reconstruction with the models resulting from the learning phase.

The compression factor is between 5 and 500 000; and preferably between 100 and 10 000. The higher the compression factor, the shorter the computing time will be in the production phase to analyze the image. However, an excessively high compression factor may lead to a model that is too coarse and ultimately unsuitable for detecting errors.

According to a second method, the model is an auto-encoder. The auto-encoder takes the form of a neural network that makes it possible to define the features in an unsupervised manner. The auto-encoder consists of two parts: an encoder and a decoder. The encoder makes it possible to compress the secondary image S_{k,p}, and the decoder makes it possible to obtain the reconstructed image R_{k,p}. According to the second method, there is one auto-encoder per batch of secondary images. Each auto-encoder has its own compression factor. According to the second method, the auto-encoders are optimized during the learning phase. The auto-encoder is optimized by comparing the reconstructed images and the initial images. This comparison makes it possible to quantify the differences between the initial images and the reconstructed images, and therefore to determine the error made by the encoder. The learning phase makes it possible to optimize the auto-encoder by minimizing the image reconstruction error.

According to a third method, the model is based on the “OMP” or “Orthogonal Matching Pursuit” algorithm. This method consists in searching for the best linear combination based on the orthogonal projection of a few images selected from a library. The model is obtained through an iterative method. Upon each addition of an image from the library, the recomposed image is improved. According to the third method, the image library is defined by the learning phase. This library is obtained by selecting a few images representative of all the images of the learning phase.

With respect to the computing the reconstructed image from the compression-decompression model, in the production phase, each primary image Aₖ of the inspected object is repositioned using the processes described above and then divided into Pₖ secondary images S_{k,p}. Each secondary image S_{k,p} undergoes a digital reconstruction operation with its model defined in the learning phase. At the end of the reconstruction operation, there is therefore one reconstructed image R_{k,p} per secondary image S_{k,p}. The operation of reconstructing each secondary image S_{k,p} with a model F_{k,p} with a compression factor Q_{k,p} makes it possible to have very short computing times. The compression factor Q_{k,p} is between 5 and 500 000, and preferably between 10 and 10 000.

According to the PCA method, which is also the preferred method, the secondary image S_{k,p} is transformed beforehand into a vector. Next, this vector is projected into the base of eigenvectors using the function F_{k,p} defined during learning. This then gives the reconstructed image R_{k,p} by transforming the obtained vector into an image. According to the second method, the secondary image is recomposed by the auto-encoder, whose parameters have been defined in the learning phase. The secondary image S_{k,p} is processed by the auto-encoder in order to obtain the reconstructed image R_{k,p}. According to the third method, the secondary image is reconstructed with the OMP or Orthogonal Matching Pursuit algorithm, whose parameters have been defined during the learning phase. See for example Tropp et al., “Signal recovery from random measurements via orthogonal matching pursuit.” IEEE Transactions on Information Theory Vol. 53, No. 12, year 2007, pp. 4655-4666, this reference herewith incorporated by reference in its entirety.

Next, the computing of the reconstruction error of each secondary image is explained. The reconstruction error results from the comparison between the secondary image S_{k,p} and the reconstructed image R_{k,p}. One method used to compute the error consists in measuring the distance between the secondary image S_{k,p} and the reconstructed image R_{k,p}. The preferred method used to compute the reconstruction error is the Euclidean distance or 2-norm. This method considers the square root of the sum of the squares of the errors.

One alternative method for computing the error consists in using the Minkowski distance, the p-distance, which is a generalization of the Euclidean distance. This method considers the p^{th} root of the sum of the absolute values of the errors to the power p. This method makes it possible to give more weight to large deviations by choosing p greater than 2. Another alternative method is the 3-norm or Chebyshev method. This method considers the maximum absolute value of the errors.

Next, the computing of the one or more scores are explained. The value of the one or more scores of the object is obtained from the reconstruction error of each secondary image. One preferred method consists in assigning the maximum value of the reconstruction errors to the score. One alternative method consists in computing the value of the score by taking the average of the reconstruction errors. Another alternative method consists in taking a weighted average of the reconstruction errors. The weighted average may be useful when the criticality of the defects is not identical in all areas of the object. Another method consists in using the Euclidean distance or the 2-norm. Another method consists in using the p-distance. Another method consists in using the Chebyshev distance or 3-norm. Other equivalent methods are of course possible within the scope of the present invention.

Once the one or more scores have been computed, their values are used to determine whether or not the product under consideration meets the desired quality conditions. If so, it is kept in production, and if not, it is marked as defective or removed from production depending on the production stage that has been reached. For example, if the products are individualized, it may be physically removed from the manufacturing process. If it is not individualized, it may be marked physically or electronically to be removed later.

Of course, the quality inspection according to the aspects of the present invention may be implemented either once in the manufacturing process (preferably at the end of production), or at several times chosen in an appropriate manner in order to avoid the complete manufacture of objects that might already be considered to be defective earlier in the manufacturing process, for example before steps that are time-consuming or require expensive means. Removing these objects earlier in the manufacturing process makes it possible to optimize it in terms of time and cost.

The various methods may be chosen in a fixed manner in a complete manufacturing process of the object (that is to say the same method is used throughout the process of manufacturing the product), or else they may be combined if several quality inspections are performed successively. It is then possible to choose the one or more most appropriate methods for the inspection to be performed.

In the present application, it should of course be understood that the process is implemented in a production machine or production that may have a high throughput (for example of at least 100 products per minute). Although, in some examples, the singular was used to define an object in production, this was done for the sake of simplicity. The process in fact applies to successive objects in production: the process is therefore iterative and repetitive on each successive object in production, and the quality inspection is performed on all the successive objects.

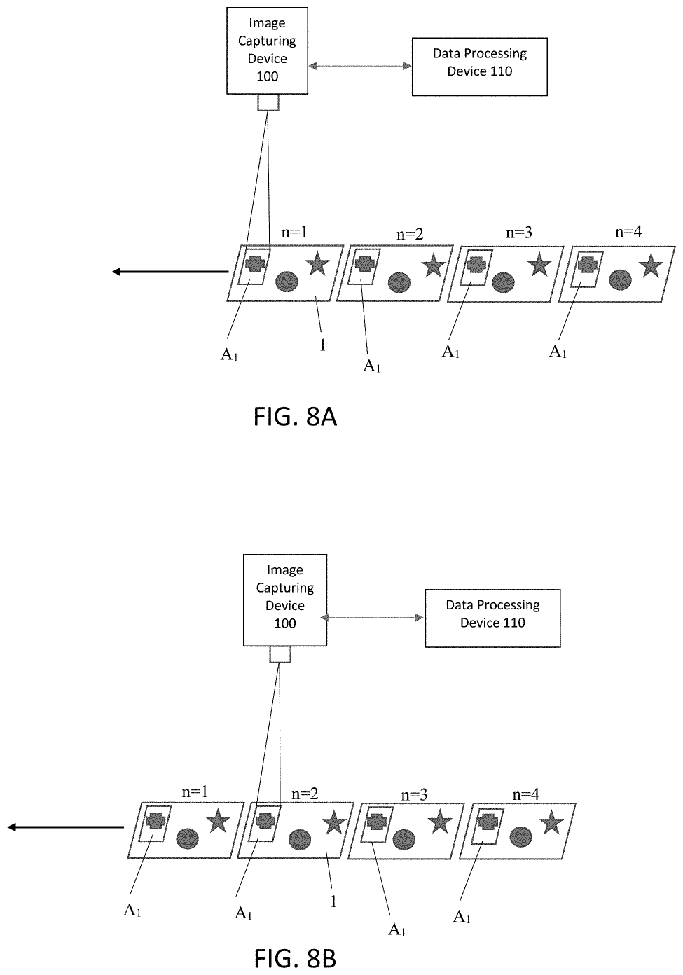

FIGS. 8A and 8B illustrate an exemplary view of the system showing an image capturing device 100 and data processing device 110 that is operatively connected to the image capturing device 100, the system shown at two different stages, for performing the image capturing and image data processing steps of the herein described method, according to another aspect of the present invention. Image capturing device 100 can include a digital camera and lens assembly that can capture images of one of the objects 1, 2, 3, and 4 or of a portion objects A₁, A₂, A₃ (see FIGS. 2 and 3) of said objects that are being manufactured by a manufacturing process, for example objects that are moved through a field of view of the camera and lens assembly, and data processing device 110 can include different types of computers, for example but not limited to a personal computer (PC), Macintosh computer (Mac), industrial data processing computer, or other types of data processors including but not limited to a microprocessor, microcontroller, embedded computer device, industrial controllers, cloud-based data processors. Also, data processing device 110 can include one or more hardware data processors and memory associated thereto, and different communication interfaces for operative interconnection with external devices, for example with a process controller that controls the manufacturing process of the objects.

FIGS. 8A and 8B also shows different objects 1 in a manufacturing process that are currently being manufactured, in the example shown four (4) objects 1 in a manufacturing process (for example as illustrated in FIG. 2) that can move into the field of view of image capturing device 100 allowing image capturing device to capture one or more images of said objects 1 or portions A₁, A₂, A₃ of the objects 1, for example by use of a conveyor of a manufacturing system or facility, and shows the capturing of one or more primary reference images A₁, A₂, A₃ during the training phase, or one or more primary images A₁, A₂, A₃ during the manufacturing phase. FIG. 8A shows a first stage where an image A₁ of a first object 1 is captured from several objects that are moved or displaced at the manufacturing facility or system, for example as a part of a manufacturing process that uses a conveyor or other displacement mechanism for moving the manufactured objects, and FIG. 8B shows a second stage where the first object has moved on to the left side and an image A₁ is captured by the second object 1 with image capturing device 100.

In a variant, it is also possible that several objects are placed in the field of view of a camera and lens assembly, and that the one or more primary reference images A₁, A₂, A₃, or primary images A₁, A₂, A₃ are extracted from each object. Also, different types of image capturing devices 100 can be used, for example ones with CCD images, linear image sensors, CMOS image sensors, including illumination devices for improving the quality of the captured images.

In addition, according to another aspect of the present invention, a non-transitory computer readable medium is provided, the computer readable medium having computer instructions recorded thereon, the computer instructions configured to perform an automated method for manufacturing objects, the method using an image capturing device and a data processing device for quality inspection, wherein the method includes a learning phase and a manufacturing phase for manufacturing the objects.

The described embodiments are described by way of illustrative examples and should not be considered to be limiting. Other embodiments may use means equivalent to those described, for example. The embodiments may also be combined with one another depending on the circumstances, or means and/or the process steps used in one embodiment may be used in another embodiment of the invention.

1. An automated method for manufacturing objects, the method using an image capturing device and a data processing device for quality inspection, the method including a learning phase and a manufacturing phase for manufacturing the objects,
wherein the learning phase comprises the steps of,
manufacturing N objects considered to be acceptable;
taking at least one reference primary image (Aₖ) of each of the N objects;
dividing each reference primary image (Aₖ) into (Pₖ) reference secondary images (S_{k,p});
grouping the corresponding reference secondary images into batches of N images; and
determining a compression-decompression model (F_{k,p}) with a compression factor (Q_{k,p}) per batch,
and wherein the manufacturing phase comprises the steps of,
taking at least one primary image of at least one object in production;
dividing each primary image into secondary images (S_{k,p});
applying the compression-decompression model and the compression factor defined in the learning phase to each secondary image (S_{k,p}) to form a reconstructed secondary image (R_{k,p});
computing the reconstruction error of each reconstructed secondary image R_{k,p};
assigning one or more scores per object based on the reconstruction errors; and
determining whether or not the produced object successfully passes the quality inspection based on the one or more assigned scores.

2. The automated method as claimed in claim 1, wherein multiple analysis is performed on at least one of the primary images initially taken, the multiple analysis providing at least one of daughter primary images that are used in place of the initially taken image from which they originate.

3. The automated method as claimed in claim 1, wherein after the step of taking at least one primary image, each primary image is repositioned.

4. The automated method as claimed in claim 1, wherein each primary image is processed, wherein the processing operation is a digital processing operation and wherein the processing operation uses at least one of a filter, and/or edge detection, and/or an application of masks, to hide certain areas of the image.

5. The automated method as claimed in claim 1, wherein the compression factor is in a range between 5 and 500,000.

6. The automated method as claimed in claim 1, wherein the compression-decompression model is determined from a principal component analysis (PCA).

7. The automated method as claimed in claim 1, wherein the compression-decompression model is determined by an auto-encoder.

8. The automated method as claimed in claim 1, wherein the compression-decompression model is determined by an Orthogonal Matching Pursuit (OMP) algorithm.

9. The automated method as claimed in claim 1, wherein the reconstruction error is computed using at least one of an Euclidean distance, and/or a Minkowski distance, and/or a Chebyshev method.

10. The automated method as claimed in claim 1, wherein the score corresponds to at least one of a maximum value of the reconstruction errors, and/or an average of the reconstruction errors, and/or a weighted average of the reconstruction errors, and/or a Euclidean distance, and/or a p-distance, and/or a Chebyshev distance.

11. The automated method as claimed in claim 1, wherein N is equal to at least 10.

12. The automated method as claimed in claim 1, wherein at least two primary images are taken, the primary images being of identical size or of different size.

13. The automated method as claimed in claim 1, wherein each primary image is divided into P secondary images of identical size or of different size.

14. The automated method as claimed in claim 1, wherein the secondary images S are juxtaposed with overlap or without overlap.

15. The automated method as claimed in claim 1, wherein the secondary images are of identical size or of different size.

16. The automated method as claimed in claim 1, the integrated quality inspection being performed at least once in the manufacturing process.

17. The automated method as claimed in claim 1, wherein the learning phase is iterative and repeated during manufacturing of the objects in a production line to take into account a difference that are not considered to be a defect.

18. The automated method as claimed in claim 1, wherein the repositioning includes a considering a predetermined number of points of interest and descriptors distributed over the image and in determining the relative displacement between the reference image and the primary image that minimizes the overlay error at points of interest and wherein the points of interest are distributed randomly in the image or in a predefined area of the image.

19. The process as claimed in claim 18, wherein the position of the points of interest is arbitrarily or non-arbitrarily predefined.

20. The process as claimed in claim 18, wherein the points of interest are detected using at least one of an image matching algorithm “SIFT”, “SURF”, “FAST”, and/or “ORB”, and the descriptors are defined by at least one of the image matching algorithms “SIFT”, “SURF”, “BRIEF”, and/or “ORB”.

21. The process as claimed in claim 18, wherein the image is repositioned along at least one axis and/or the image is repositioned in rotation about the axis perpendicular to the plane formed by the image and/or the image is repositioned by combining a translational and rotational movement.

22. An automated system including an image capturing device and a data processing device, the data processing device configured to perform image data processing for quality inspection of manufactured objects,
the data processing device is further configured to perform a method including a learning phase and a manufacturing phase,
the learning phase comprising the steps of,
manufacturing N objects considered to be acceptable;
taking at least one reference primary image (Aₖ) of each of the N objects with the image capturing device;
dividing each reference primary image (Aₖ) into (Pₖ) reference secondary images (S_{k,p});
grouping the corresponding reference secondary images into batches of N images; and
determining a compression-decompression model (F_{k,p}) with a compression factor (Q_{k,p}) per batch,
and wherein the manufacturing phase comprises the steps of,
taking at least one primary image with the image capturing device of at least one object in production;
dividing each primary image into secondary images (S_{k,p});
applying the compression-decompression model and the compression factor defined in the learning phase to each secondary image (S_{k,p}) to form a reconstructed secondary image (R_{k,p});
computing the reconstruction error of each reconstructed secondary image R_{k,p};
assigning one or more scores per object based on the reconstruction errors; and
determining whether or not the produced object successfully passes the quality inspection based on the one or more assigned scores.
